(19) United States
(12) Patent Application Publication
(10) Pub. No.: US 2024/0351405 A1
(43) Pub. Date: Oct. 24, 2024

(54) Rear Window Clip

(71) Applicant: Brian Goldwitz, Waterbury, CT (US)

(72) Inventor: Brian Goldwitz, Waterbury, CT (US)

(21) Appl. No.: 18/138,732

(22) Filed: Apr. 24, 2023

(51) Int. Cl. B60J 1/20

(52) U.S. Cl. CPC B60J 1/20

(57) ABSTRACT

The current invention is a rear window closing clip that can be used to assist in closing the rear window of soft tops for SUV and similar vehicles. The clip will consist of a securing plate, a base and a securing screw. The window fold will be secured by a hook in the base and held into the clip by the securing plate which is attached the base using a securing screw. The window will be closed using flipping motion of the base adding leverage to the action. This smooth action prevents any tearing or undo wear on the soft top window.

### TECHNICAL FIELD

The technology discussed below relates a rear window closing clip and more particularly one that works with vehicle soft tops.

### RELATED APPLICATIONS

None.

### BACKGROUND

People with SUVs and jeeps sometimes have an open top that can be covered with a soft top. When extending the soft top to cover the top of the vehicle it can be difficult to close the rear window due to the tension in the soft top.

There currently are no devices or ways to easily close the rear window of the soft top easily and efficiently.

There is still room for improvement in the art.

### SUMMARY

The current invention is a rear window closing clip that can be used to assist in closing the rear window of soft tops for SUV and similar vehicles. The clip will help to close and hold the window in a closed position. The clip will consist of a securing plate, a base and a securing screw. The window fold will be secured by a hook in the base and held into the clip by the securing plate which is attached the base using a securing screw. The window will be closed using flipping motion of the base adding leverage to the action. This smooth action prevents any tearing or undo wear on the soft top window.

These are improvements over the current art.

### DRAWINGS

FIG. 1 shows a vehicle with a soft top;

FIG. 2 shows the clip attached to the rear window;

FIG. 3 shows another view of the clip attaching the window flap to the soft top;

FIG. 4 shows a close up view of the clip attaching the window flap to the soft top;

FIG. 5 shows the securing plate securing the clip;

FIGS. 6a, b and c show the securing plate being secured;

FIG. 7 show a cut away view of the clip and the securing plate;

FIG. 8 shows a top view of the securing plate;

FIG. 9 shows a side view of the clip;

FIG. 10 is an expanded view of the securing screw, the securing plate and the clip;

FIG. 11 shows a side view of current device securing the window flap;

FIG. 12 shows different securing plat designs; and

FIG. 13 shows different clip embodiments.

### MAIN COMPONENTS

1 clip
10 base
20 Securing Plate
30 Securing screw

### DETAILED DESCRIPTION

The illustrations presented herein are, in some instances, not actual views of any particular framing devices or components thereof but may be idealized representations which are employed to describe the present disclosure. Additionally, elements common between figures may retain the same numerical designation.

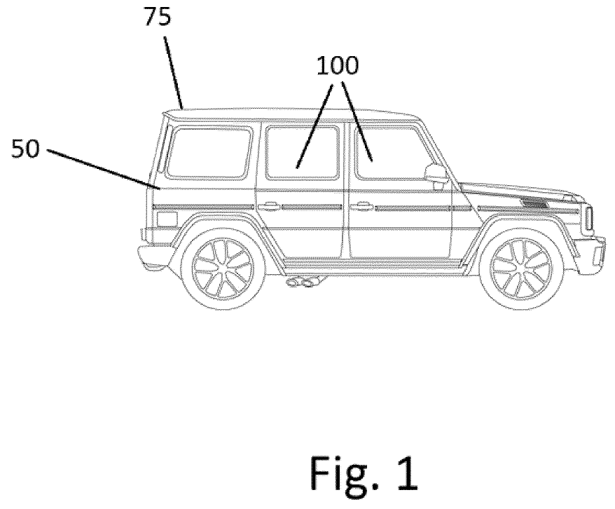

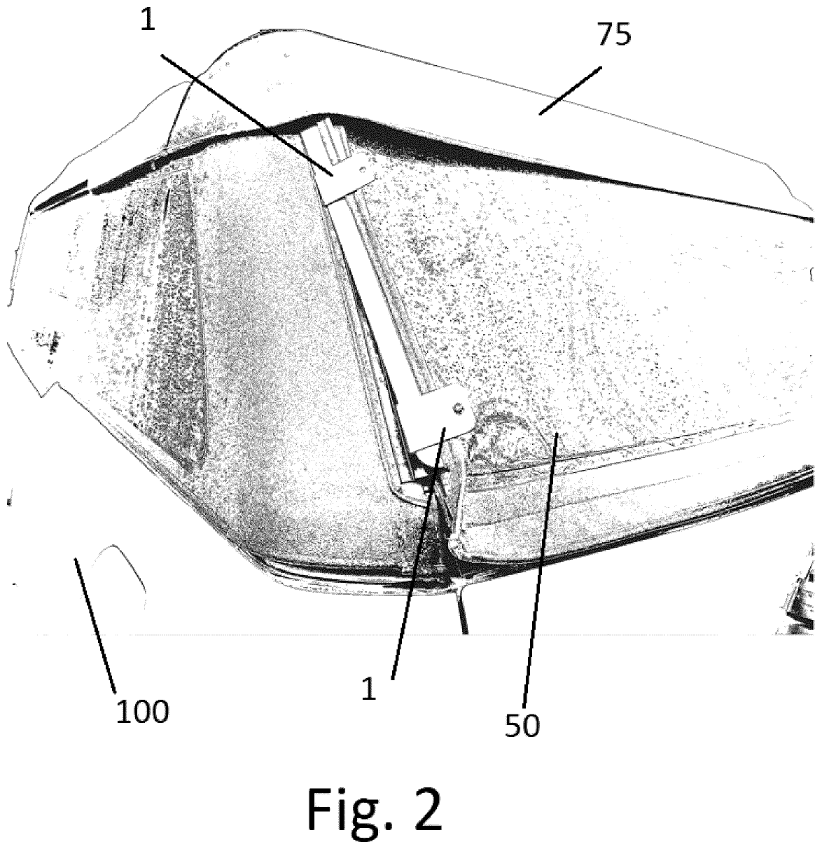

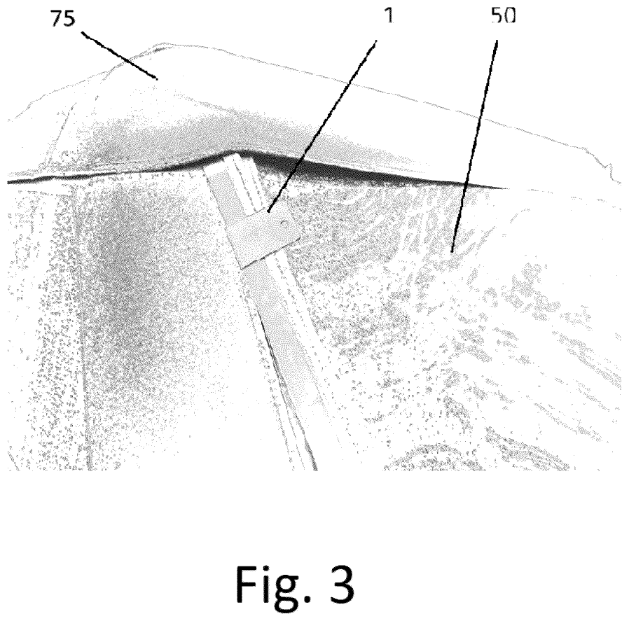

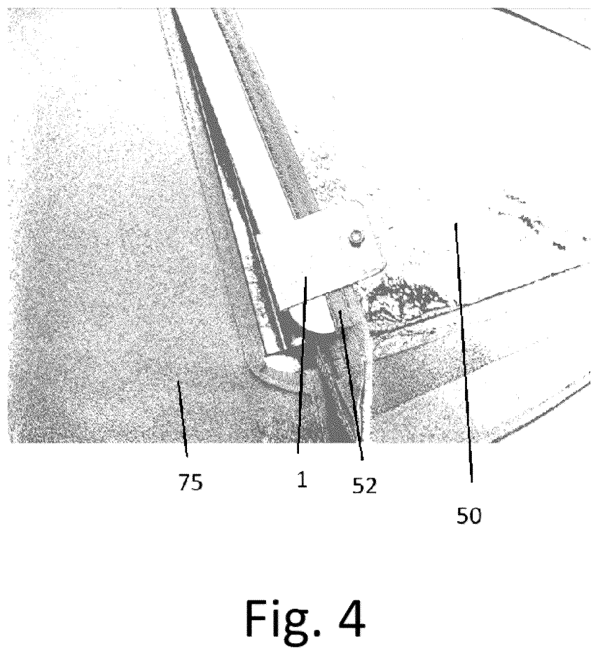

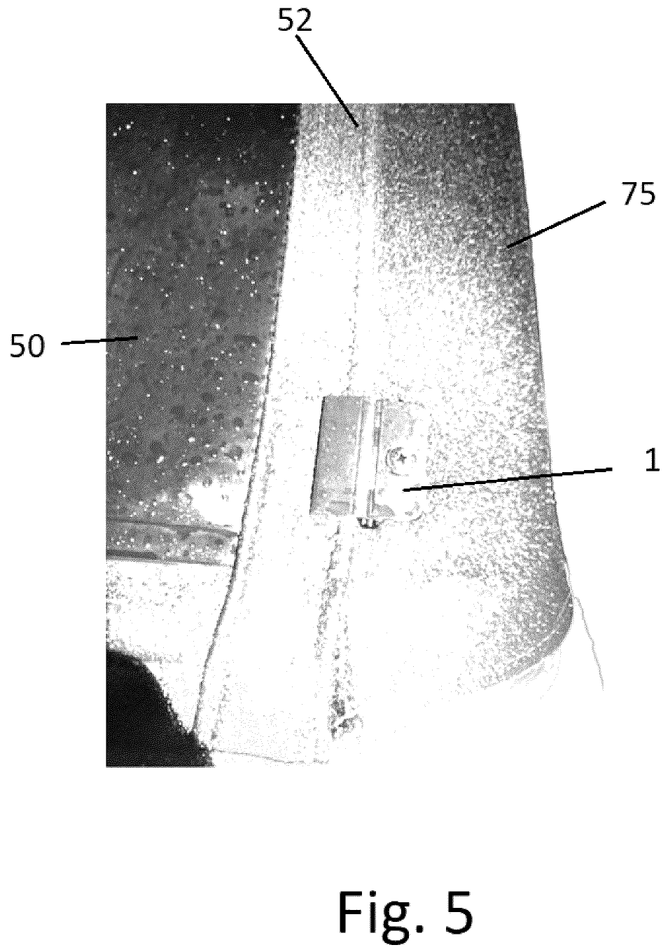

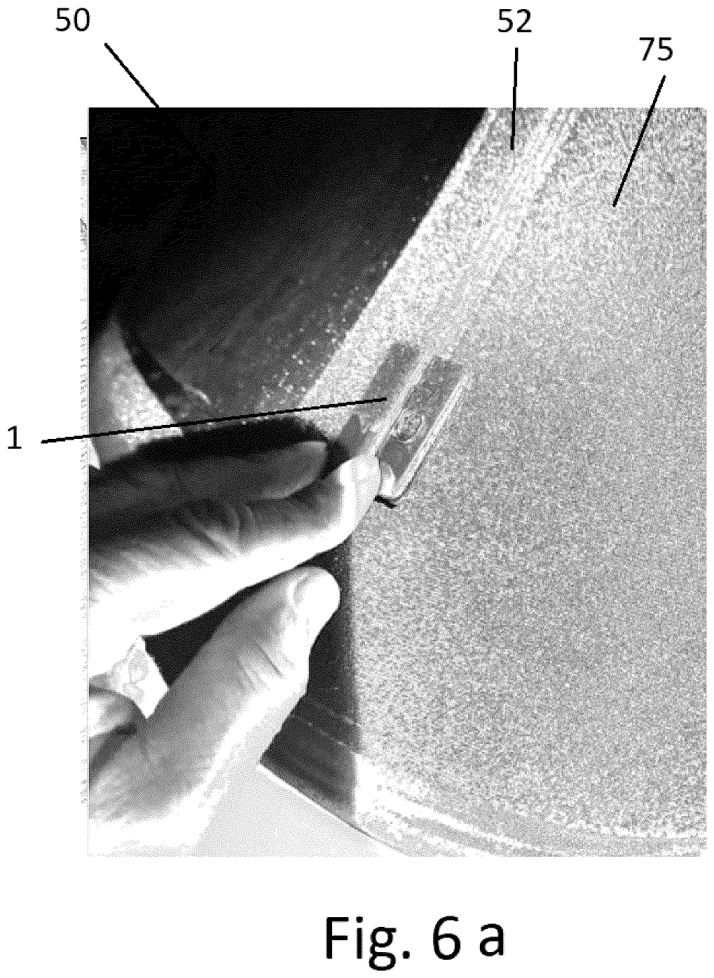

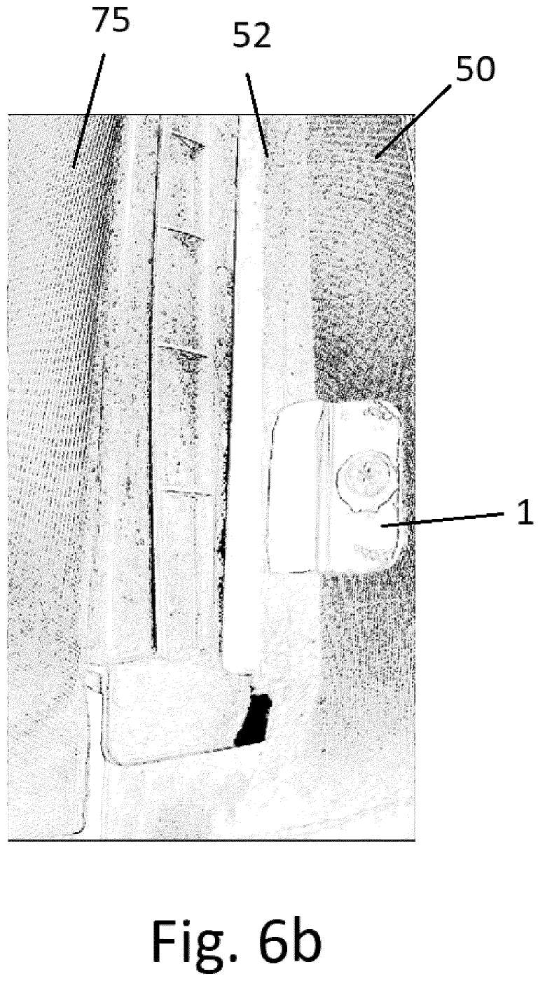

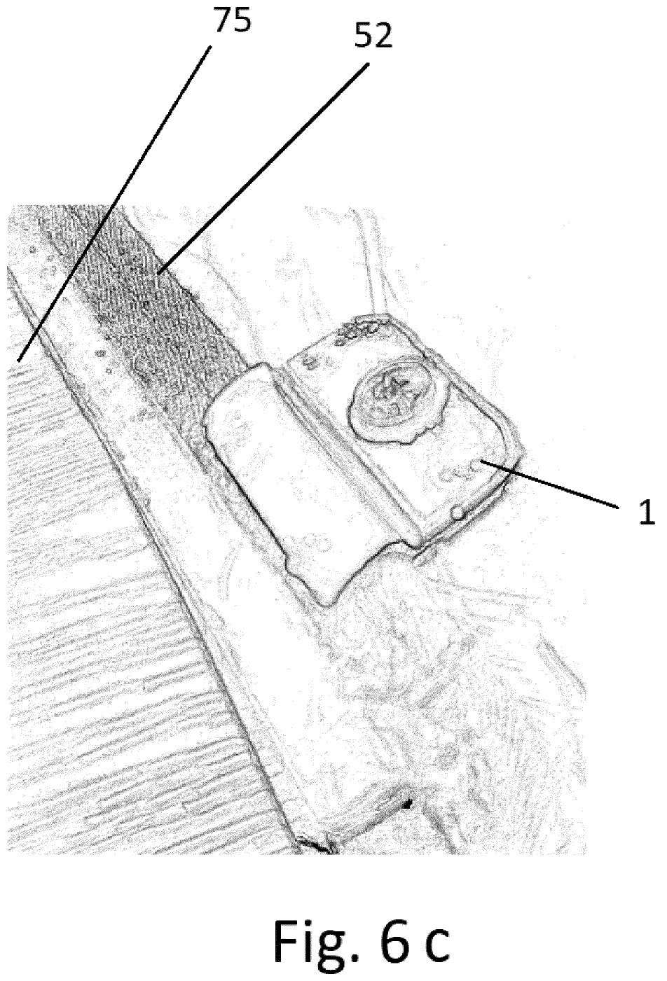

The current invention is an improved securing clip 1 as shown in FIGS. 2 through 13. FIG. 1 shows a view of the soft top vehicle 100 with a soft top 75 and a soft top window 50.

FIGS. 2 through 13 show a rear window closing clip 1 that can be used to assist in closing the rear window 50 of soft tops 75 for SUV and similar vehicles. The clip 1 will assist in the closing of the rear window and the holding the window in a closed position.

In the preferred embodiment, the clip 1 will consist of a securing plate 20, a base 10 and a securing screw 30. The window fold 52 will be secured by a hooked shape in the base 10 and held into the clip 1 by the securing plate 20 which is attached the base 10 using a securing screw 30.

As shown in FIGS. 2, 3, 4, 5, 6a, 6b and 6c, the clip 1 secures the window fold 52 and turns pulling the window 50 tight and flat against the soft top 75. This turning motion acts as a lever easing the effort to securing the window 50. This smooth action prevents any tearing or undo wear on the soft top window 50.

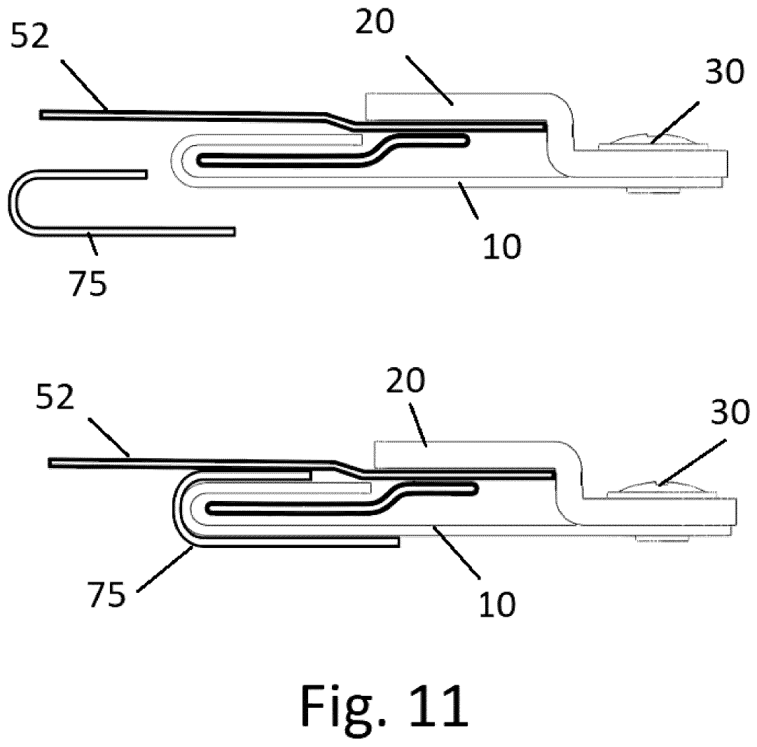

The clip 1 can also attach to the window edge of the soft top 75 by as shown by FIG. 11 by an attaching means or wrapping around the end of the base 10 and secured against the window fold 52.

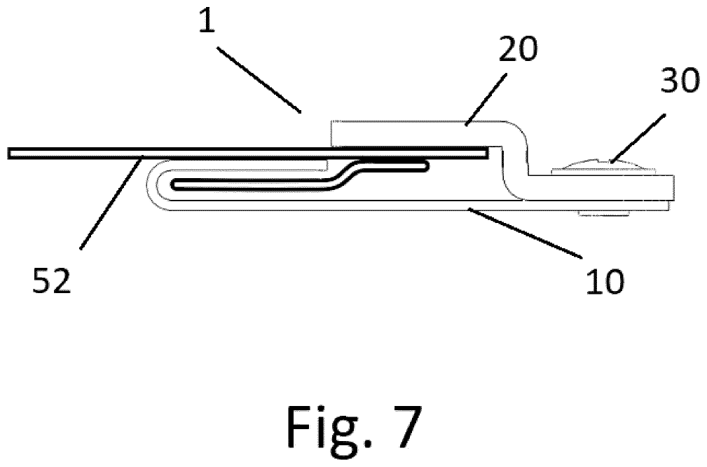

As shown in FIG. 7, the window fold 52 is hooked by the base 10 and held in place by the securing plate 20 with the securing plate 20 being attached to the base 10 by one or more securing screws 30.

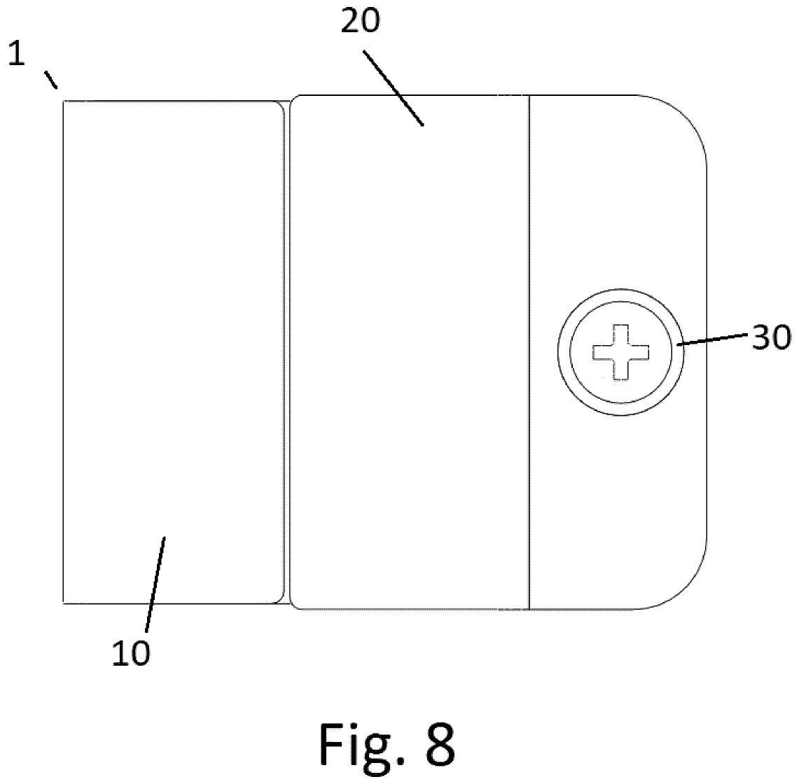

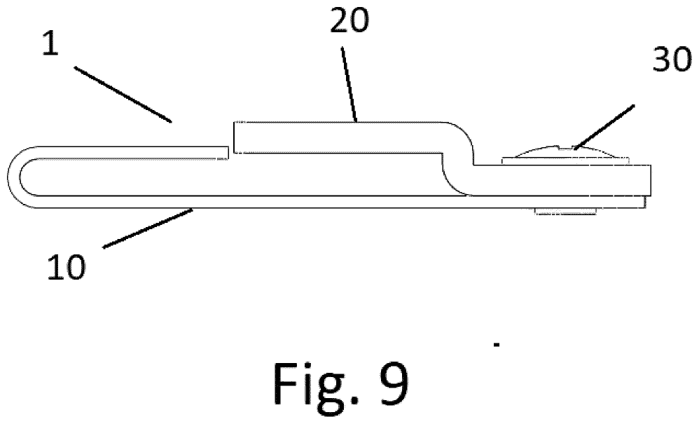

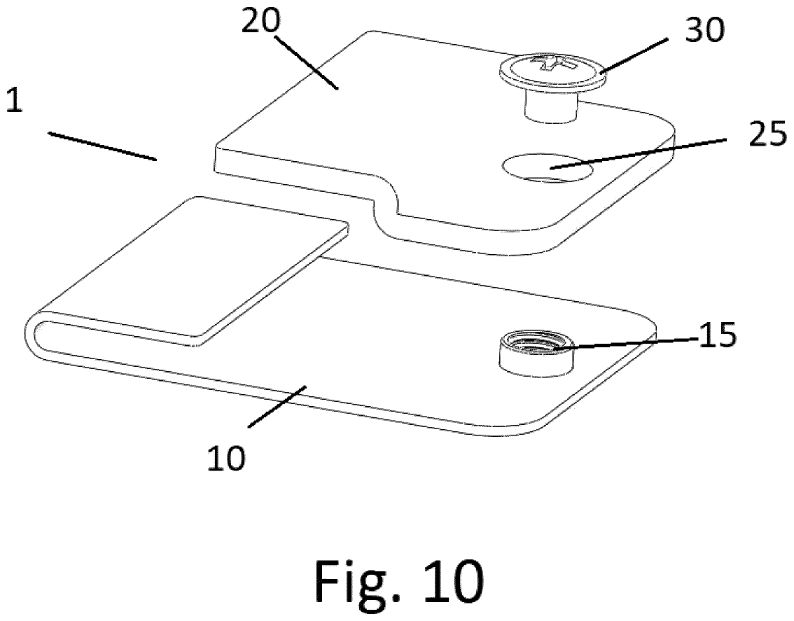

FIG. 8 shows a top view of the clip 1 with the securing plate 20 attached to the base 10 by the securing screw 30. FIG. 9 shows a side view of one embodiment of the clip 1. FIG. 10 shows the clip's 1 main components. The base 10 is flat with one end that curves up and around in a hook shape. The base 10 has a threaded screw receiver 15 that extends up from the top flat surface of the base 10. In the preferred embodiment the screw receiver 15 is centered at the non-hooked end of the base 10. The securing plate 20 is flat with a slight upward bend which allows the window fold 52 to be placed on the base 10 and to secure the window fold 52. The securing plate 20 will have a plate opening 25 that is slightly larger than the screw receiver 15 which fits through it. The securing screw 30 with a head that is larger than the plate opening 25 and is screwed into the screw receiver 15 to secure the securing plate 20 to the base 10.

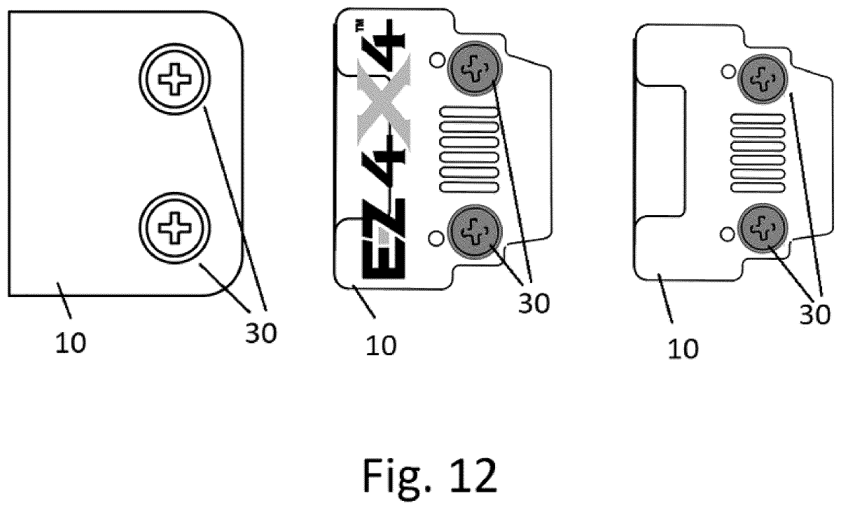

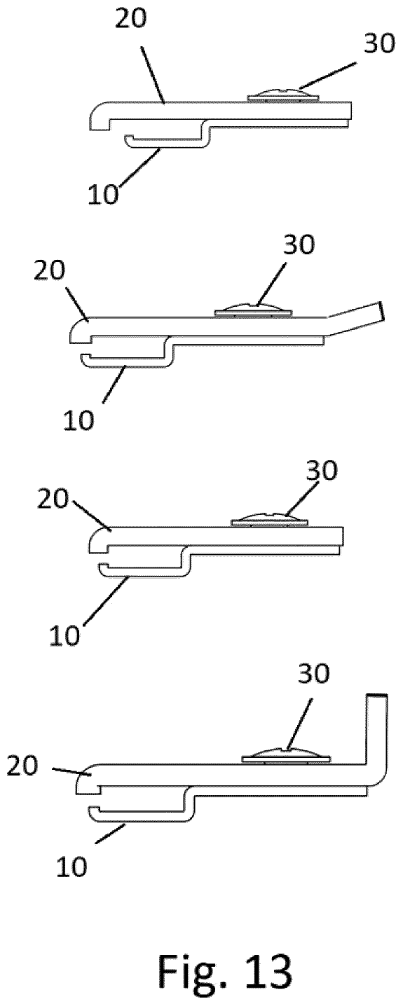

The securing plate 20 can have additional embodiments as shown in FIGS. 12 and 13 as well as more than one securing screw 30 to attached to the base 10. The securing plate 20 can have other shapes of the plate 20. The securing plate 20 could be flat with a have a downward slope at the end that secures the window fold 52. Another embodiment could have the securing plate 20 having a angle that can be at a slight or a right angle or any angle between.

The various features associate with the examples described herein and shown in the accompanying drawings can be implemented in different examples and implementations without departing from the scope of the present disclosure. Therefore, although certain specific constructions and arrangements have been described and shown in the accompanying drawings, such embodiments are merely illustrative and not restrictive of the scope of the disclosure, since various other additions and modifications to, and deletions from, the described embodiments will be apparent to one of ordinary skill in the art.

What is claimed is:

1. A device comprising:
a clip to close a window of a soft top vehicle having a base, a securing plate and a plurality of screwing screws.

2. The device according to claim 1 further comprising:
where the base is flat with a hooked end.

3. The device according to claim 1 further comprising:
where the base has a secure receiver.

4. The device according to claim 1 further comprising:
where the securing plate has a plate opening.

5. The device according to claim 1 further comprising:
where the a securing plate is secured to the base by a plurality of screwing screws.
